(19) United States
(12) Patent Application Publication
(10) Pub. No.: US 2023/0168168 A1
(43) Pub. Date: Jun. 1, 2023

(54) High-Efficiency Particle Analysis Method

(71) Applicant: KUNMING PROSPECTING DESIGN INSTITUTE OF CHINA NONFERROUS METALS INDUSTRY CO., LTD, Kunming (CN)

(72) Inventors: Wenlian LIU, Kunming (CN); Xianwei GONG, Kunming (CN); Fei DING, Kunming (CN); Guo TANG, Kunming (CN); Yunhui WU, Kunming (CN); Jun LIU, Kunming (CN); SuGang SUI, Kunming (CN); Jiansen WU, Kunming (CN); Ying BAI, Kunming (CN); Ting ZHENG, Kunming (CN); Zongming XU, Kunming (CN); Bin LEI, Kunming (CN); Hongchun PAN, Kunming (CN); Xufeng WANG, Kunming (CN); Tian ZHANG, Kunming (CN); Hanhua XU, Kunming (CN); Xiong WANG, Kunming (CN)

(73) Assignee: KUNMING PROSPECTING DESIGN INSTITUTE OF CHINA NONFERROUS METALS INDUSTRY CO., LTD, Kunming (CN)

(21) Appl. No.: 17/920,810

(22) PCT Filed: May 17, 2021
(86) PCT No.: PCT/CN2021/094218

§ 371 Date: Oct. 24, 2022

(30) Foreign Application Priority Data
Jun. 15, 2020 (CN) 202010542940.9

(51) Int. Cl. G01N 15/02; G01N 9/36

(52) U.S. Cl. CPC G01N 15/0272; G01N 9/36

(57) ABSTRACT

A high-efficiency particle analysis method includes the following steps: taking representative air-dried samples and measuring a moisture content; boiling, sieving, weighing and adding a dispersant; conducting a particle analysis test; reading four readings of 1^{st} to 59^{th} and 60^{th} to 90^{th} samples; and drawing a particle size distribution curve showing the relationship between the particle size and the percentage of below a certain diameter. According to the method, a time difference is used to change the measurement mode, and the four readings of the 59^{th} and 90^{th} samples are read in a cycling manner; and a novel test method is provided on the premise of ensuring quality, thus greatly improving the efficiency of a particle analysis test and meeting production requirements.

### BACKGROUND OF THE INVENTION

### 1. Technical Field

The invention belongs to the technical field of geotechnical test methods, and particularly relates to a high-efficiency particle analysis method.

### 2. Description of Related Art

A particle analysis test, as a very important indoor geotechnical routine test, provides the basis for soil naming, liquefaction judgment of foundation soil and engineering investigation. The particle analysis test mainly measures the content of each particle size in soil samples, so as to carry out grading analysis of particles, and is mainly realized by a sieve analysis method, a densimeter method or a pipette method. The densimeter method is suitable for samples with particle sizes less than 0.075 mm. In the actual production process, a combined measurement method (i.e. combination of the sieve analysis method and the densimeter method) and the densimeter method are often used. According to the standard for geotechnical testing method GB/T50123-2019, a suspension is stirred for 1 min, then a stopwatch is immediately started, and readings of a densimeter at different times are recorded. Each time the readings are read, the densimeter should be put into the suspension 10-20 s before a scheduled time, then the readings of the densimeter at different times are recorded, and only readings of 24 soil samples can be recorded each time, which is inefficient and can not meet production requirements. Therefore, how to improve the work efficiency while meeting the engineering quality is an urgent problem to be solved.

In view of this, the present invention is proposed.

### BRIEF SUMMARY OF THE INVENTION

The technical problem to be solved by the invention is to overcome the shortcomings of the prior art by providing a high-efficiency particle analysis method. To solve the above technical problem, the basic idea of the technical scheme adopted by the invention is as follows.

A high-efficiency particle analysis method comprises the following steps:

Step 1, taking representative air-dried samples and measure a moisture content;

Specifically, air-dried samples are preferred for a test; each air-dried sample is 30 g and treated separately; when the moisture content in an air-dried sample is measured, an oven is cleaned first, baking with samples for other tests should be avoided, and a moisture content box should be covered with a layer of filter paper with good air permeability if conditions permit so as to prevent sample pollution;

Step 2, boiling, sieving, weighing and adding a dispersant;

Specifically, the samples are poured into a 500 ml conical flask in a triangular cup, 200 ml of pure water is added, and heating is conducted for 40 min; after repeatedly sieving to clean sand grains, water removal, drying and weighing are conducted, and then fine sieve analysis is conducted; a sieved suspension is poured into a measuring cylinder, 10 ml of 4% sodium hexametaphosphate is added as a dispersant, then pure water is injected to 1000 ml, and the mixture is left to stand for one night; other dispersants should be adopted for samples which still coagulate after sodium hexametaphosphate is added, till the samples do not coagulate;

Step 3, conducting a particle analysis test;

Specifically, according to the standard, the suspension is stirred up and down along a suspension depth for 1 min with a stirrer, a stopwatch is started as soon as the stirrer is taken out, and then readings of a densimeter at 1.5 min, 25 min, 60.5 min and 150 min are recorded. 59 samples are stirred continuously and readings are read in turn; after a first reading (1.5 min) of a 24^{th} sample is read, the time is 24.5 min; a second reading (25 min) of the first sample is read, then a first reading (25.5 min) of a 25^{th} sample, a second reading (26 min) of a second sample, a first reading (26.5 min) of a 26^{th} sample and a second reading (27 min) of a third sample are read, and so on, till a first reading (59.5 min) of a 59^{th} sample and a second reading (60 min) of a 36^{th} sample are read; after that, a third reading (60.5 min) of the first sample is read, and a second reading (61 min) of a 37^{th} sample and a third reading (61.5 min) of the second sample are read till a second reading (83 min) of the 59^{th} sample and a third reading (83.5 min) of a 24^{th} sample are read; and then the rest of the samples are read in turn till a third reading (118.5 min) of the 59^{th} sample is read;

Step 4, reading fourth readings (150 min-208 min) of the 1^{st} to 59^{th} samples in turn; specifically, each test can complete 59 samples, with a total time of 208 min and an average time of 3.5 min for one sample, and compared with a traditional method, the number of samples is increased by 145.8% and the time is increased by 51.4%;

Step 5, organizing the readings of the densimeter, and drawing a particle size distribution curve showing the relationship between the particle size and the percentage of below a certain diameter after calculation.

Further, in step 4, till a third reading (118.5 min) of the 59^{th} sample, after reading a third reading (116.5 min) of a 57^{th} sample, a 60^{th} sample is stirred, and so on, till a 90^{th} sample is stirred; after reading the third reading (118.5 min) of the 59^{th} sample, a first reading (119 min) of the 60^{th} sample is read, and so on, till a first reading (142 min) of a 83^{rd} sample is read, then a second reading (142.5 min) of the 60^{th} sample, a first reading (143 min) of a 84^{th} sample, a second reading (143.5 min) of a 61^{st} sample, and the first reading (144 min) of the 84^{th} sample are read till a first reading (149 min) of the 90^{th} sample and a second reading (149.5 min) of a 67^{th} sample are read, then the fourth reading (150 min) of the first sample, a second reading (150.5 min) of a 68^{th} sample, the fourth reading (151 min) of the second sample and a second reading (151.5 min) of the 69^{th} sample are read, and so on, till a fourth reading (172 min) of a 23^{rd} sample and a second reading (172.5 min) of the 90^{th} sample are read; and then, a fourth reading (173 min) of a 24^{th} sample, and a fourth reading (174 min) of a 25^{th} sample to a fourth reading (177 min) of a 28^{th} sample are read, after that, a third reading (177.5 min) of a 60^{th} sample, a fourth reading (178 min) of a 29^{th} sample, a third reading (178.5 min) of a 61^{st} sample and a fourth reading (179 min) of a 30^{th} sample are read till a third reading (207.5 min) of the 90^{th} sample and a fourth reading (208 min) of the 59^{th} sample are read, and finally fourth readings (267.5 min-297.5 min) of the 60^{th} sample to the 90^{th} sample are read in turn. Each test can complete 90 samples, the total time is 297.5 min, and the average time of one sample is 3.3 min. Compared with a traditional method, the number of samples is increased by 275% and the time is increased by 54.2%.

In order to make full use of the time difference, the densimeter readings at 1.5 min, 25 min, 60.5 min and 150 min are recorded for the 1^{st} to 59^{th} samples, and the densimeter readings at 1.5 min, 25 min, 60 min and 150 min are recorded for the 60^{th} to 90^{th} samples.

After the technical scheme is adopted, compared with the prior art, the invention has the following beneficial effects.

The invention provides a novel densimeter method. According to the method, a time difference is used to change the measurement mode, and the four readings of the 59^{th} and 90^{th} samples are read in a cycling manner; and a novel test method is provided on the premise of ensuring quality, thus greatly improving the efficiency of a particle analysis test and meeting production requirements.

### DETAILED DESCRIPTION OF THE INVENTION

In order to make the purpose, technical scheme and advantages of the embodiments of the invention more clear, the technical scheme in the embodiments will be clearly and completely described below. The following embodiments are used to illustrate the present invention, but are not used to limit the scope of the present invention.

### Embodiment 1

A high-efficiency particle analysis method comprises the following steps.

Step 1, representative air-dried samples are taken and a moisture content is measured.

Air-dried samples were preferred for a test. Each air-dried sample was 30 g and treated separately. The sample was placed in a moisture content box which was put in an oven to measure the moisture content. When the moisture content in an air-dried sample was measured, the oven was cleaned first, baking with samples for other tests should be avoided, and the moisture content box should be covered with a layer of filter paper with good air permeability if conditions permit so as to prevent sample pollution.

Step 2, boiling, sieving, weighing are conducted and a dispersant is added.

The samples were poured into a triangular cup, 200 ml of pure water was added, and heating was conducted for 40 min. After repeatedly sieving to clean sand grains, water removal, drying and weighing were conducted, and then fine sieve analysis was conducted according to a standard procedure. A sieved suspension was poured into a measuring cylinder, 10 ml of 4% sodium hexametaphosphate was added as a dispersant, and then pure water was injected to 1000 ml. Other dispersants should be adopted for samples which still coagulate after sodium hexametaphosphate was added.

Step 3, a particle analysis test is conducted.

According to the standard, the suspension was stirred up and down along a suspension depth for 1 min with a stirrer, a stopwatch was started immediately, and then readings of a densimeter at 1.5 min, 25 min, 60.5 min and 150 min were recorded. 59 samples were stirred continuously and readings were read in turn. After a first reading (1.5 min) of a 24^{th} sample was read, the time was 24.5 min; a second reading (25 min) of the first sample was read, then a first reading (25.5 min) of a 25^{th} sample, a second reading (26 min) of a second sample, a first reading (26.5 min) of a 26^{th} sample and a second reading (27 min) of a third sample were read, and so on, till a first reading (59.5 min) of a 59^{th} sample and a second reading (60 min) of a 36^{th} sample were read; after that, a third reading (60.5 min) of the first sample was read, and a second reading (61 min) of a 37^{th} sample and a third reading (61.5 min) of the second sample were read till a second reading (83 min) of the 59^{th} sample and a third reading (83.5 min) of a 24^{th} sample were read; and then the rest of the samples were read in turn till a third reading (118.5 min) of the 59^{th} sample was read.

Step 4, fourth readings (150 min-208 min) of the 1^{st} to 59^{th} samples were read in turn to complete a first modified particle analysis test. Each test can complete 59 samples, with a total time of 208 min and an average time of 3.5 min for one sample. Compared with a traditional method, the number of samples is increased by 145.8% and the time is increased by 51.4%.

| | Number of samples | | | | | | | | | | |
|---|---|---|---|---|---|---|---|---|---|---|---|
| Setting | Reading Time | | | | | | | | | | |
| time | 1 | 2 | . . . | 24 | 25 | . . . | 36 | 37 | . . . | 58 | 59 |
| 1.5 | 1.5 | 2.5 | | 24.5 | 25.5 | | 36.5 | 37.5 | | 58.5 | 59.5 |
| 25 | 25 | 26 | | 48 | 49 | | 60 | 61 | | 82 | 83 |
| 60.5 | 60.5 | 61.5 | | 83.5 | 84.5 | | 95.5 | 96.5 | | 117.5 | 118.5 |
| 150 | 150 | 151 | | 173 | 174 | | 185 | 186 | | 207 | 208 |

Step 5, the readings of the densimeter are organized, and a particle size distribution curve showing the relationship between the particle size and the percentage of below a certain diameter is drawn after calculation.

### Embodiment 2

This embodiment is a further improvement of Embodiment 1, in which the step 4 is conducted as follows.

In step 4, till a third reading (118.5 min) of the 59^{th} sample, after reading a third reading (116.5 min) of a 57^{th} sample, a 60^{th} sample was stirred, and so on, till a 90^{th} sample was stirred; after reading the third reading (118.5 min) of the 59^{th} sample, a first reading (119 min) of the 60^{th} sample was read, and so on, till a first reading (142 min) of a 83^{rd} sample was read, then a second reading (142.5 min) of the 60^{th} sample, a first reading (143 min) of a 84^{th} sample, a second reading (143.5 min) of a 61^{st} sample, and the first reading (144 min) of the 85^{th} sample were read till a first reading (149 min) of the 90^{th} sample and a second reading (149.5 min) of a 67^{th} sample were read, then the fourth reading (150 min) of the first sample, a second reading (150.5 min) of a 68^{th} sample, the fourth reading (151 min) of the second sample and a second reading (151.5 min) of the 69^{th} sample were read, and so on, till a fourth reading (172 min) of a 23^{rd} sample and a second reading (172.5 min) of the 90^{th} sample were read; and then, a fourth reading (173 min) of a 24^{th} sample, and a fourth reading (174 min) of a 25^{th} sample to a fourth reading (177 min) of a 28^{th} sample were read, after that, a third reading (177.5 min) of a 60^{th} sample, a fourth reading (178 min) of a 29^{th} sample, a third reading (178.5 min) of a 61^{st} sample and a fourth reading (179 min) of a 30^{th} sample were read till a third reading (207.5 min) of the 90^{th} sample and a fourth reading (208 min) of the 59^{th} sample were read, and finally fourth readings (267.5 min-297.5 min) of the 60^{th} sample to the 90^{th} sample were read in turn to complete a second modified particle analysis test. Each test can complete 90 samples, the total time is 297.5 min, and the average time of one sample is 3.3 min. Compared with a traditional method, the number of samples is increased by 275% and the time is increased by 54.2%.

It should be noted that the densimeter readings at 1.5 min, 25 min, 60.5 min and 150 min were recorded for the 1^{st} to 59^{th} samples, and the densimeter readings at 1.5 min, 25 min, 60 min and 150 min were recorded for the 60^{th} to 90^{th} samples.

| | Number of samples | | | | | | | | | | |
|---|---|---|---|---|---|---|---|---|---|---|---|
| Setting | Reading Time | | | | | | | | | | |
| time | 1 | 2 | . . . | 24 | 25 | . . . | 36 | 37 | . . . | 58 | 59 |
| 1.5 | 1.5 | 2.5 | | 24.5 | 25.5 | | 36.5 | 37.5 | | 58.5 | 59.5 |
| 25 | 25 | 26 | | 48 | 49 | | 60 | 61 | | 82 | 83 |
| 60.5 | 60.5 | 61.5 | | 83.5 | 84.5 | | 95.5 | 96.5 | | 117.5 | 118.5 |
| 150 | 150 | 151 | | 173 | 174 | | 185 | 186 | | 207 | 208 |

Note: The samples were stirred in two batches, the first batch was the 1^{st} to 59^{th} samples, which were continuously stirred; and the second batch was the 60^{th} to 90^{th} samples, which were continuously stirred.

| | Number of samples | | | | | | | | | | |
|---|---|---|---|---|---|---|---|---|---|---|---|
| Setting | Reading Time | | | | | | | | | | |
| time | 60 | 61 | . . . | 67 | 68 | . . . | 83 | 84 | . . . | 89 | 90 |
| 1.5 | 119 | 120 | | 126 | 127 | | 142 | 143 | | 148 | 149 |
| 25 | 142.5 | 143.5 | | 149.5 | 150.5 | | 165.5 | 166.5 | | 171.5 | 172.5 |
| 60 | 177.5 | 178.5 | | 184.5 | 185.5 | | 200.5 | 201.5 | | 206.5 | 207.5 |
| 150 | 267.5 | 268.5 | | 274.5 | 275.5 | | 290.5 | 291.5 | | 296.5 | 297.5 |

Note: The second batch of samples were stirred after a third reading (116.5 min) of a 57^{th} sample in the first batch was read. A stopwatch was used for accurate control throughout the process.

### Comparative Example

According to an existing densimeter method, dry samples were ground first, particles over 2 mm were screened out, and particles below 2 mm were boiled and dispersed to obtain a suspension; and according to the standard, the suspension was stirred up and down along a suspension depth for 1 min with a stirrer, a stopwatch was started immediately, and then readings of a densimeter at 1.5 min, 25 min, 60 min and 150 min were recorded. 24 samples were continuously stirred and read in turn. After a first reading (1.5 min) of a 24^{th} sample was read, the time was 24.5 min, and then a second reading (25 min) of the first sample was read. After all the 24 samples were read, a third reading (60 min) and a fourth reading (150 min) were read in turn. Only 24 samples can be completed in each test.

| | Number of samples | | | | |
|---|---|---|---|---|---|
| | 1 | 2 | . . . | . . . | 24 |
| Setting time | Reading Time | | | | |
| 1.5 | 1.5 | 2.5 | | | 24.5 |
| 25 | 25 | 26 | | | 48 |
| 60.5 | 60.5 | 61.5 | | | 83.5 |
| 150 | 150 | 151 | | | 173 |

The existing densimeter method in the comparative example can test 24 samples each time, Embodiment 1 can test 59 samples each time, and Embodiment 2 can test 90 samples each time. The method of the invention does not simply add 59-90 samples to the existing method, but changes the measurement mode by using the time difference to realize the reading of 59-90 samples, and achieve the purpose of particle analysis by a densimeter method. Based on actual conditions, a novel test method is provided on the premise of ensuring quality, thus greatly improving the efficiency of a particle analysis test and meeting production requirements.

The above description is only preferred embodiments of the present invention, and is not intended to limit the present invention in any way. Although the present invention has been disclosed with reference to the preferred embodiments, it is not intended to limit the present invention. Any person familiar with this patent can make some changes or modifications to equivalent embodiments with equivalent changes by using the above-mentioned technical contents without departing from the scope of the technical scheme of the present invention. However, any simple amendments, equivalent changes and modifications made to the above embodiments according to the technical essence of the present invention without departing from the contents of the technical scheme of the present invention still fall within the scope of the scheme of the present invention.

What is claimed is:

1. A high-efficiency particle analysis method, comprising:
step 1, taking a first plurality of representative air-dried samples with each one weighing 30 g and being treated separately, placing the first plurality of representative air-dried samples in a moisture content box, covering the moisture content box with a layer of filter paper with a good air permeability, and putting the moisture content box in an oven fora moisture content measurement;
step 2, respectively pouring the first plurality of representative air-dried samples into a 500 ml conical flask, adding 200 ml of a pure water, and conducting heating for 40 min to obtain a second plurality of samples; after repeatedly sieving to clean sand grains, conducting a water removal, drying and weighing, and then conducting a fine sieve analysis; pouring a sieved suspension into a measuring cylinder, adding 10 ml of a dispersant, then injecting the pure water to 1000 ml to form a mixture, and leaving the mixture to stand for one night;
step 3, stirring the sieved suspension up and down along a suspension depth for 1 min with a stirrer, starting a stopwatch as soon as the stirrer is taken out, and then recording readings of a densimeter at 1.5 min, 25 min, 60.5 min, and 150 min; stirring 59 samples of the second plurality of samples continuously and reading the readings in turn; after a first reading of a 24^{th} sample is read, reading a second reading of the first sample, then reading a first reading of a 25^{th} sample, a second reading of a second sample, a first reading of a 26^{th} sample and a second reading of a third sample, and so on, till a first reading of a 59^{th} sample and a second reading of a 36^{th} sample are read; after that, reading a third reading of the first sample, and reading a second reading of a 37^{th} sample and a third reading of the second sample till a second reading of the 59^{th} sample and a third reading of a 24^{th} sample are read; and then reading the rest of the second plurality of samples in turn till a third reading of the 59^{th} sample is read;
step 4, reading fourth readings of the 1^{st} to 59^{th} samples of the second plurality of samples in turn; and
step 5, organizing the readings of the densimeter, and drawing a particle size distribution curve showing a relationship between a particle size and a percentage of below a certain diameter after a calculation.

2. The high-efficiency particle analysis method according to claim 1, wherein in the step 4, after reading a third reading of a 57^{th} sample, a 60^{th} sample is stirred, and so on, till a 90^{th} sample is stirred; after reading the third reading of the 59^{th} sample, a first reading of the 60^{th} sample is read, and so on, till a first reading of an 83^{rd} sample is read, then a second reading of the 60^{th} sample, a first reading of an 84^{th} sample, a second reading of a 61^{st} sample, and a first reading of an 85^{th} sample are read till a first reading of the 90^{th} sample and a second reading of a 67^{th} sample are read, then the fourth reading of the first sample, a second reading of a 68^{th} sample, the fourth reading of the second sample and a second reading of the 69^{th} sample are read, and so on, till a fourth reading of a 23^{rd} sample and a second reading of the 90^{th} sample are read; and then, a fourth reading of a 24^{th} sample to a fourth reading of a 28^{th} sample are read, after that, a third reading of a 60^{th} sample, a fourth reading of a 29^{th} sample, a third reading of a 61^{st} sample and a fourth reading of a 30^{th} sample are read till a third reading of the 90^{th} sample and a fourth reading of the 59^{th} sample are read, and finally fourth readings of the 60^{th} sample to the 90^{th} sample are read in turn.

3. The high-efficiency particle analysis method according to claim 2, wherein the densimeter readings at the 1.5 min, the 25 min, the 60.5 min, and the 150 min are recorded for the 1^{st} to 59^{th} samples of the second plurality of samples, and the densimeter readings at the 1.5 min, the 25 min, the 60 min, and the 150 min are recorded for the 60^{th} to 90^{th} samples of the second plurality of samples.

4. The high-efficiency particle analysis method according to claim 1, wherein in the step 2, the dispersant is 4% sodium hexametaphosphate, and other dispersants are adopted for a part of the second plurality of samples with a coagulation after the 4% sodium hexametaphosphate is added, till the part of the second plurality of samples do not coagulate.
